(19) United States
(12) Patent Application Publication
(10) Pub. No.: US 2025/0154765 A1
(43) Pub. Date: May 15, 2025

(54) Construction method for concrete structure integrated with waveguide tube

(71) Applicant: KOREA TESTING LABORATORY, Jinju-si (KR)

(72) Inventors: Hong Je Jang, Jinju-si (KR); Han Hee Lee, Jinju-si (KR); Tae-seung Song, Jinju-si (KR); Sang Wook Yoon, Jinju-si (KR); Hyo Sik Choi, Jinju-si (KR)

(73) Assignee: KOREA TESTING LABORATORY, Jinju-si (KR)

(21) Appl. No.: 18/440,456

(22) Filed: Feb. 13, 2024

(30) Foreign Application Priority Data
Nov. 14, 2023 (KR) 10-2023-0157680

(51) Int. Cl. E04C 3/294; E04C 3/22; E04C 5/02; E04C 5/16; H01P 5/107

(52) U.S. Cl. CPC E04C 3/294; E04C 5/163; E04C 5/168; E04C 3/22; E04C 5/02; H01P 5/107

(57) ABSTRACT

The present invention provides construction methods for a concrete structure integrated with a waveguide tube, including: installing formwork that conforms to the shape and size of the concrete structure (C), referred to as a formwork installation step; installing a form tie system, including waveguide tube (40), between first formwork and second formwork, referred to as form tie installation step; pouring concrete after the first formwork, the second formwork, and the form tie system are completely installed, referred to as concrete pouring step; and removing the formwork and the form tie system, excluding the waveguide tube (40), after the concrete has initially hardened, referred to as a formwork removal step.

### CROSS-REFERENCE TO RELATED APPLICATIONS

This application claims priority to and the benefit of Korean Patent Application No. KR 10-2023-0157680 filed Nov. 14, 2023, the entire disclosure of which is hereby incorporated herein by reference.

### BACKGROUND OF THE DISCLOSURE

5G primarily utilizes high-frequency bands, which can be easily obstructed by building structures, especially concrete structures. Such obstructions become more pronounced with higher frequencies; in the case of millimeter-wave signals, concrete structures pose a significant obstacle.

Due to the limited propagation range of millimeter-wave frequencies, strategies are being employed such as densely installing small cells in urban areas and inside buildings to enhance signal coverage and connectivity. Additionally, using devices like signal repeaters or relays that capture weak signals, amplify them, and retransmit, or employing beamforming techniques to concentrate signal transmission towards specified devices or directions are attempted. However, practically, the installation of dedicated 5G antennas or Wi-Fi access points inside buildings is being pursued to expand and improve indoor coverage.

Another approach under investigation involves minimizing signal interference by selecting materials with high 5G signal penetration during the design or remodeling stages of buildings. However, there is a demand for more extensive and innovative solutions to address these challenges in the future.

### SUMMARY OF THE DISCLOSURE

This summary is provided to introduce a selection of concepts that are further described below in the detailed description. This summary is not intended to identify indispensable features of the claimed subject matter, nor is it intended for use as an aid in limiting the scope of the claimed subject matter.

The present disclosure introduces methods for a constructing concrete structure with an integrated waveguide tube. An example implementation of the method includes: installing formwork that conforms to the shape and size of the concrete structure; installing a form tie system, including a waveguide tube, between first formwork and second formwork; pouring concrete after the first formwork, the second formwork, and the form tie system are completely installed; and removing the formwork and the form tie system, excluding the waveguide tube, after the concrete has initially hardened.

The present disclosure also introduces a concrete structure, wherein a waveguide tube capable of transmitting high-frequency band frequencies is embedded within the concrete.

These and additional aspects of the present disclosure are set forth in the description that follows, and/or may be learned by a person having ordinary skill in the art by reading the material herein and/or practicing the principles described herein. At least some aspects of the present disclosure may be achieved via means recited in the attached claims.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a process diagram of an example implementation of a construction method for a concrete structure (C) equipped with a waveguide tube (40) according to one or more aspects of the present disclosure.

FIG. 2 is a sectional view of an example implementation of a form tie system used in a construction method for concrete structure (C) equipped with a waveguide tube (40) according to one or more aspects of the present disclosure.

FIG. 3 is a perspective view of a concrete structure (C) equipped with waveguide tube (40) according to one or more aspects of the present disclosure.

FIG. 4 and FIG. 5 are charts illustrating standard data for a waveguide tube (40) according to one or more aspects of the present disclosure.

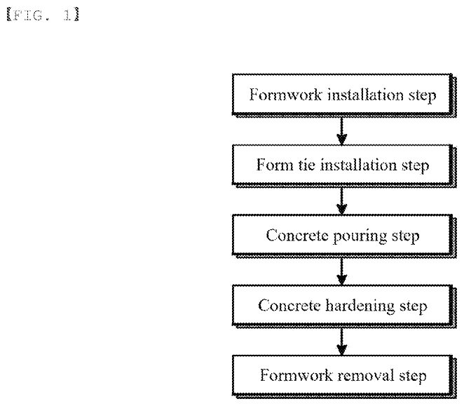

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

Aspects of the present disclosure aim to provide a method for constructing a concrete structure that allows electromagnetic waves of the 5G band to pass through. An example method for constructing a concrete structure according to one or more aspects of the present disclosure includes: installing formwork that conforms to the shape and size of the concrete structure (C), referred to as a formwork installation step; installing a form tie system, including waveguide tube (40), between first formwork and second formwork, referred to as form tie installation step; pouring concrete after the first formwork, the second formwork, and the form tie system are completely installed, referred to as concrete pouring step; and removing the formwork and the form tie system, excluding the waveguide tube (40), after the concrete has initially hardened, referred to as a formwork removal step.

The form tie system may comprise: a tie bolt (30) that penetrates both the first formwork and the second formwork; a first nut (10a) located on the outside of the first formwork; a first washer (20a) situated adjacent to the first nut (10a) on the inside of the first formwork; a second nut (20b) located on the outside of the second formwork; and a second washer (10b) situated adjacent to the second nut (20b) on the inside of the second formwork.

The first nut (10a) and the first washer (20a) may be integrated and equipped with the waveguide tube (40).

The second nut (20b) and the second washer (10b) may be integrated.

A spacer (50) may be located between the first nut (10a) and the first formwork, and between the second nut (20b) and the second formwork.

The waveguide tube (40) may have a rectangular cross-section, a width ranging from 15 to 25 mm, a height ranging from 5 to 15 mm, and a width-to-height ratio of 1:0.4 to 1:0.6.

The waveguide tube (40) may be round in shape.

The waveguide tube (40) may include an insulating coating layer on its exterior surface.

The present disclosure also introduces a concrete structure, wherein a waveguide tube (40) capable of transmitting high-frequency band frequencies is embedded within the concrete.

The waveguide tube (40) may be provided with an insulating coating layer on its exterior surface.

Methods of constructing a concrete structure equipped with a waveguide tube according to one or more aspects of the present disclosure permit easily installing a waveguide tube inside concrete structure without excessively modifying the existing process. Consequently, this permits the concrete structure to easily allow the propagation of high-frequency waves.

Before describing the present invention in detail, it should be understood that the terms used in this specification are for the purpose of describing particular embodiments only and are not intended to limit the scope of the invention, which is defined solely by the claims attached hereto. All technical and scientific terms used in this specification, unless otherwise indicated, have the same meaning as commonly understood by one of ordinary skill in the art to which this invention belongs.

Throughout this specification and the claims, unless otherwise specified, the term “comprise” (or any form of comprise, such as comprises and comprising) is intended to mean that it includes the mentioned item, step, or group of items and steps, and does not exclude the presence of any other item, step, or group of items or steps.

Additionally, in the figures, the width, length, thickness, and angles of components may be exaggerated for convenience. The figures are described from the observer's point of view. When one component is said to be “on/under” or “above/below” another component, this includes not only the case where it is directly on top or directly underneath the other component, but also the case where there is another component in between them.

Meanwhile, various embodiments of the present invention can be combined with any other embodiments, unless there is a clear indication to the contrary. In particular, any feature indicated as preferable or advantageous may be combined with any other feature or features indicated as preferable or advantageous.

Referring to the figures, a more detailed description will be given of an example construction method for a concrete structure (C) equipped with a waveguide tube (40) according to one or more aspects of the present disclosure. The construction method includes a formwork installation step, a form tie installation step, a concrete pouring step, and a formwork removal step.

In the formwork installation step, formwork is installed according to the shape and size of the concrete structure (C). Formwork is generally made of steel, plywood, or plastic materials. A form known as Euroform is widely used in practice. Euroform is designed for easy installation and removal, allowing for rapid progress in work. Typically, formwork is installed with a first formwork and a second formwork facing each other to form the space into which the concrete will be poured.

The form tie installation step involves installing form ties between first formwork and second formwork. The form ties serve to bind formworks together to maintain a stable distance and position between formwork panels, preventing instability in formwork due to the pressure exerted during the concrete pouring.

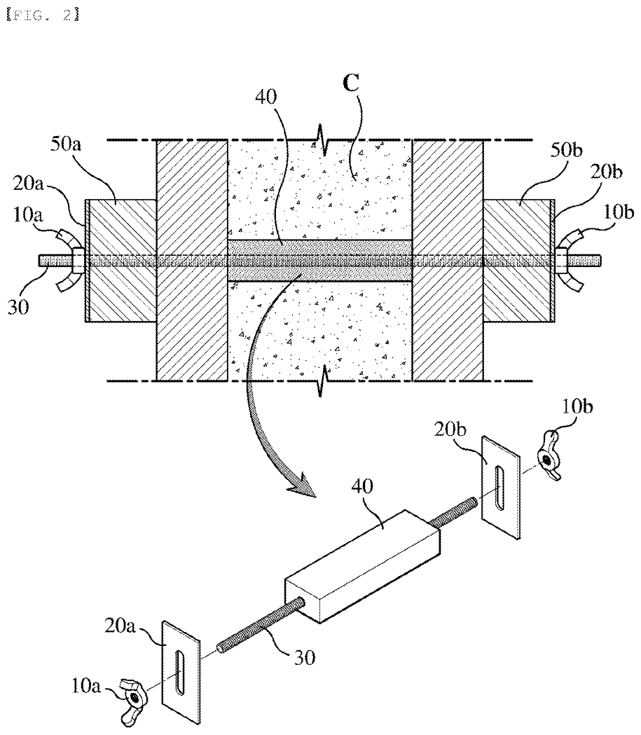

FIG. 2 illustrates an example implementation of the form tie system according to one or more aspects of the present disclosure, in which the form tie system includes the first nut (10a), the first washer (20a), the tie bolt (30), the second washer (10b), the second nut (20b), and the waveguide tube (40). The first nut (10a) is provided on the outside of first formwork. The first washer (20a) is provided on the inside of first nut (10a). The second nut (20b) is provided on the outside of second formwork. The second washer (10b) is provided on the inside of second nut (20b). Various types of nuts, such as wing nuts, and washers, such as butterfly washers, trilobe washers, or square washers, can be used.

The distance between the first formwork and the second formwork determines the shape and thickness of the concrete. The tie bolt (30) maintains a consistent distance and alignment between formwork panels. The waveguide tube (40) facilitates the easy removal of the form tie after the concrete has set and prevents direct contact between the concrete and form tie, thereby preventing corrosion of the form tie.

Washers and nuts are positioned at both ends of the tie bolt (30) to securely fix form tie to formwork panels and to adjust the precise spacing between panels.

Optionally, the spacer (50) can be placed between the formwork and the nut to maintain a consistent distance between the form tie and the formwork, and to prevent direct contact between the concrete and form tie.

Installation is accomplished by threading the tie bolt (30) through the first nut (10a), the first washer (20a), the waveguide tube (40), the second washer (10b), and the second nut (20b), and then tightening nuts on both sides.

During construction, the waveguide tube (40) acts as a component of the form tie, forming the pathway for the tie bolt (30) to pass through, and after construction, it serves as a pathway for the propagation of electromagnetic waves. Consequently, the waveguide tube (40) may be made of materials that are resistant to corrosion and capable of propagating electromagnetic waves, such as brass, nickel and zinc-plated steel, copper, or aluminum. Since the waveguide tube operates across various frequency bands, the size and material selection of the waveguide tube (40) can vary depending on the specific frequency range targeted.

The waveguide tube (40) may have a rectangular cross-section. For example, the width may be between 15 to 25 mm, the height may be between 5 to 15 mm, and the width-to-height ratio may be between 1:0.4 to 1:0.6. In an example implementation, the waveguide tube has a rectangular cross-section measuring 20.2×10 mm and a thickness of 2 mm.

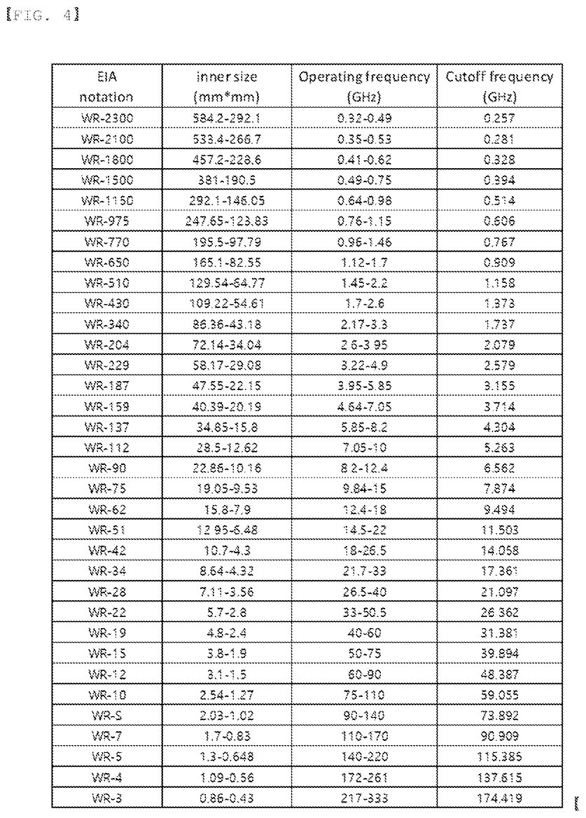

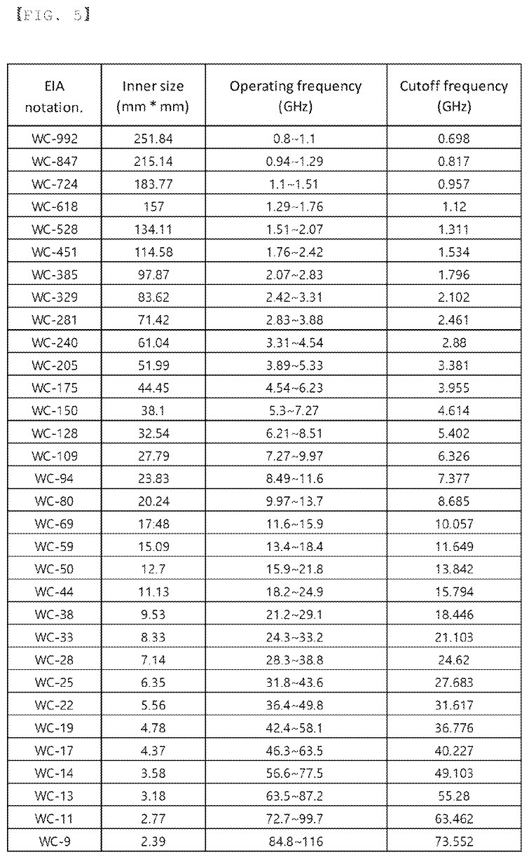

The waveguide tube (40) is designed to overcome the dielectric losses of a coaxial line by using air as the insulator and eliminates the central conductor that causes conductor losses, thereby functioning as a transmission line. While a rectangular waveguide tube (40) can be used, for very high frequencies with wavelengths between 1 and 10 mm, a circular waveguide tube (40) with lower TE10 mode losses may be employed. FIG. 4 and FIG. 5 illustrate the standard data for the waveguide tube (40).

Additionally, the waveguide tube (40) can be equipped with a corrosion-resistant coating layer on its exterior to prevent corrosion. This coating layer on the exterior is selected to adhere well to the surface of the waveguide tube (40) and may be made of an insulating material that does not peel or crack over time.

When forming the waveguide tube (40) from copper or aluminum, materials such as epoxy, polyurethane, Physical Vapor Deposition (PVD), or polyethylene can be used for the coating layer. Additionally, when forming the waveguide tube (40) from aluminum, an aluminum oxide layer (anodizing) can be used as the material for the coating layer.

The aforementioned range is a condition for the waveguide tube (40) to transmit high-frequency electromagnetic waves that cannot pass through concrete due to diffraction. If these conditions are not met, the performance of the waveguide tube (40) as a conduit for these waves diminishes.

In other words, since the waveguide tube (40) is installed as a component of the form tie during construction, it can be installed in the concrete structure (C) using a process similar to that used for embedding PVC pipes in embedded form tie constructions. This allows for the installation of the waveguide tube (40) in the concrete structure (C) without the need for additional processes or costs.

In another embodiment of the form tie system, unlike the previously mentioned embodiment, a wingnut plate, in which the nut and washer are integrally formed, can be used.

The concrete pouring step involves injecting concrete after the formwork and form tie systems have been completely installed. During this process, the form tie system withstands the pressure of the concrete while maintaining a consistent spacing between the formwork panels.

The formwork removal step is the process of removing the external formwork panels after the concrete has hardened. The appropriate timing for removing the formwork panels can vary depending on the type of concrete, temperature, humidity, additives used, and the size and shape of the structure. However, it should at least be after the initial hardening has occurred. Initial hardening refers to the state where the concrete has gained sufficient strength to support its own weight and any additional working loads.

The removal of the form tie system occurs either before or simultaneously with the removal of the formwork panels. In this step, the formwork, first nut (10a), first washer (20a), tie bolt (30), second washer (10b), and second nut (20b) are removed. However, the waveguide tube (40) is not removed and remains inside the concrete structure (C).

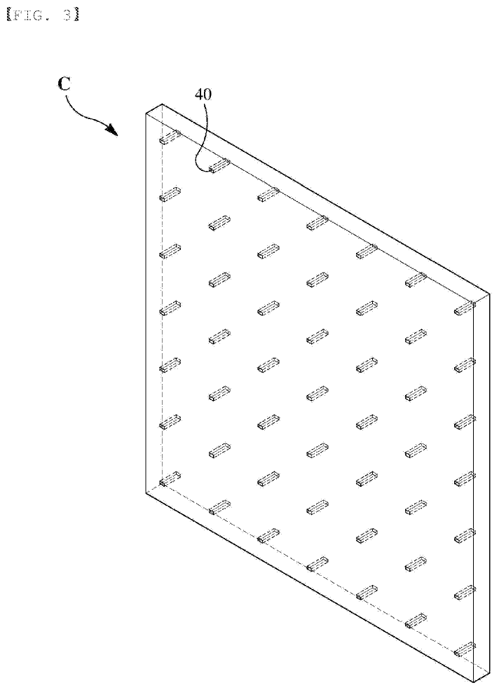

Another aspect of this invention pertains to the concrete structure (C) equipped with the waveguide tube (40). FIG. 3 illustrates the waveguide tube (40) that remains inside the concrete. According to this, the concrete structure (C) is formed according to the aforementioned construction method of the concrete structure (C), with the waveguide tube (40) installed at regular intervals inside it. An example of the concrete structure (C) is a concrete wall.

The concrete structure is equipped with multiple waveguide tubes (40) embedded within the concrete. In an example implementation, the waveguide tube (40) has a rectangular cross-section, with example dimensions being a width of 15 to 25 mm and a height of 5 to 15 mm. The width-to-height ratio may be between 1:0.4 to 1:0.6. For example, the waveguide tube may have a rectangular cross-section measuring 20.2×10 mm and a thickness of 2 mm.

The waveguide tube (40) functions as a transmission line that overcomes the dielectric losses of a coaxial line by using air as the insulator and eliminates the central conductor, which causes conductor losses. A rectangular waveguide tube (40) can be employed due to its rectangular cross-section. However, for very high frequencies with wavelengths between 1 and 10 mm, a circular waveguide tube (40) with lower TE10 mode losses may also be used. The interior of waveguide tube (40) can be filled with materials that have minimal electromagnetic interference, such as styrofoam, for insulation and soundproofing purposes.

As previously described, the waveguide tube (40) can be equipped with a corrosion-resistant coating layer on its exterior to prevent corrosion. This coating layer on the exterior is selected to adhere well to the surface of waveguide tube (40) and may be made of an insulating material that does not peel or crack over time.

When forming the waveguide tube (40) from copper or aluminum, materials such as epoxy, polyurethane, Physical Vapor Deposition (PVD), or polyethylene can be used for the coating layer. Additionally, when forming the waveguide tube (40) from aluminum, an aluminum oxide layer (anodizing) can be used as the material for the coating layer.

The concrete structure (C) is designed such that electromagnetic waves can propagate through the waveguide tube (40). Consequently, even in the case of high frequencies, electromagnetic waves can be transmitted inside the concrete structure without being blocked.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. § 1.72 (b) to permit the reader to quickly ascertain the nature of the technical disclosure. It is submitted with the understanding that it will not be used to interpret or limit the scope or meaning of the claims.

What is claimed is:

1. A method for constructing concrete structure with integrated waveguide tube, the method comprising:
installing formwork that conforms to the shape and size of the concrete structure (C), wherein the formwork includes a first formwork and a second formwork;
installing a form tie system, including a waveguide tube (40), between the first formwork and the second formwork;
pouring concrete after the first formwork, the second formwork, and the form tie system are completely installed; and
removing the formwork and the form tie system, excluding the waveguide tube (40), after the concrete has initially hardened.

2. The method of claim 1, wherein the form tie system comprises:
a tie bolt (30) that penetrates both the first formwork and the second formwork;
a first nut (10a) located on the outside of the first formwork;
a first washer (20a) situated adjacent to the first nut (10a) on the inside of the first formwork;
a second nut (20b) located on the outside of the second formwork; and
a second washer (10b) situated adjacent to the second nut (20b) on the inside of the second formwork.

3. The method of claim 2, wherein the first nut (10a) and the first washer (20a) are integrated and equipped with the waveguide tube (40).

4. The method of claim 3, wherein the second nut (20b) and the second washer (10b) are integrated.

5. The method of claim 4, further comprising a spacer (50) located between the first nut (10a) and the first formwork, and between the second nut (20b) and the second formwork.

6. The method of claim 5, wherein the waveguide tube (40) has a rectangular cross-section, a width ranging from 15 to 25 mm, a height ranging from 5 to 15 mm, and a width-to-height ratio of 1:0.4 to 1:0.6.

7. The method of claim 6, wherein the waveguide tube (40) is round in shape.

8. The method of claim 7, wherein the waveguide tube (40) includes an insulating coating layer on its exterior surface.

9. A concrete structure, wherein a waveguide tube (40) capable of transmitting high-frequency band frequencies is embedded within the concrete.

10. The concrete structure of claim 9, wherein the waveguide tube (40) is provided with an insulating coating layer on its exterior surface.
